(19) United States
(12) Patent Application Publication
(10) Pub. No.: US 2026/0349422 A1
(43) Pub. Date: Nov. 5, 2026

(54) INFORMATION PROCESSING SYSTEM, INFORMATION PROCESSING METHOD, AND PROGRAM

(71) Applicants: Sees Co., Ltd., Tokyo (JP); NAGASE & CO., LTD., Osaka (JP)

(72) Inventor: Hisao ITO, Tokyo (JP)

(21) Appl. No.: 18/870,114

(22) PCT Filed: Mar. 29, 2023
(86) PCT No.: PCT/JP2023/012920

§ 371 Date: Jul. 17, 2026

(30) Foreign Application Priority Data
Jun. 2, 2022 (JP) 2022-090429

(51) Int. Cl. G05B 23/02; G06T 17/05

(52) U.S. Cl. CPC G05B 23/02; G06T 17/05

(57) ABSTRACT

The present invention addresses the problem of improving the convenience of management of facilities that are managed on the basis of data from a plurality of sensors or cameras. In an information processing system including a server 1 that performs a prescribed process using input data, and one or more input cells 2 that provide at least a portion of the input data to the server 1, each input cell 2 acquires positional information of the input cell. The server 1 manages input cell position information and models, within a three-dimensional map of the facilities where the input cells 2 are located. Each input cell 2 performs relearning on the basis of information about the three-dimensional map managed by the server 1 and the positional information of the input cell 2. This solves the above-mentioned problem.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims priority from International PCT Patent Application No. PCT/JP 2023/012920, filed Mar. 29, 2023 entitled “INFORMATION PROCESSING SYSTEM, INFORMATION PROCESSING METHOD, AND PROGRAM”, which claims priority to Japanese Application No.: 2022-090429, filed Jun. 2, 2022, all of which are incorporated herein by reference in their entirety.

### TECHNICAL FIELD

The present invention relates to an information processing system, an information processing method, and a program.

### BACKGROUND ART

Conventionally, there has been a technique for manufacturing a better product by changing parameters by control of various devices based on parameters measured by various sensors in the premises (e.g., factory) (see, e.g., Patent Document 1). Moreover, recently, an artificial intelligence (hereinafter referred to as “AI”) technique has been developed. For example, an AI capable of performing natural language processing, which is used for, e.g., chatbot, has also been developed.

### CITATION LIST

### Patent Document

Patent Document 1: Japanese Unexamined Patent Application, Publication No. 2013-111073.

### SUMMARY OF THE INVENTION

### Problems to be Solved by the Invention

Conventionally, for, e.g., breakdown detection/prediction from the operation statuses of various devices used in the premises, e.g., focused detection and determination and alarm output has been made using various sensors by software in a central management device. However, in a case where, e.g., an accident has occurred and data (abnormal values) is transmitted at once from many sensors, a central monitoring device sequentially performs processing, and for this reason, it takes a considerable amount of time to undertake measures, such as outputting an alarm to a user (e.g., guard) or operating emergency equipment (e.g., fire extinguishing by a sprinkler). This may lead to a delay in undertaking measures and lead to a major disaster. For this reason, there has been a demand for a system which is capable of more quickly starting to undertake measures and is available without needing a large centralized system.

The present invention can improve convenience in management of equipment based on data from a plurality of sensors or cameras.

### Means for Solving the Problems

To accomplish the above-described object, an information processing system of one aspect of the present invention is an information processing system including a central device that executes predetermined processing using input data, and one or more first peripheral devices that provide the central device with at least part of the input data. The central device includes a processing executer that acquires, as input data, one or more pieces of perceptually-expressed data, executes predetermined processing using the input data, and outputs, as output data, one or more pieces of perceptually-expressed data indicating a processing execution result, and each of the one or more first peripheral devices includes a model manager that manages a model for receiving predetermined data, converting the predetermined data into the perceptually-expressed data, and outputting the perceptually-expressed data with the model stored in a predetermined storage medium, and a converter that acquires data output from a sensor that measures a physical quantity in a real world or a camera that images a target region, inputs the data to the model, and outputs the perceptually-expressed data from the model as at least part of the input data for the central device.

An information processing method and a program according to one aspect of the present invention is an information processing method and a program corresponding to the information processing system of the above-described aspect of the present invention.

### Effects of the Invention

According to the present invention, the convenience in the management of the equipment based on the data from the plurality of sensors or cameras can be improved.

### BRIEF DESCRIPTION OF THE DRAWINGS

FIG. 1 is a schematic diagram for describing one example of the outline of a service to which an “autonomous-decentralized AI blockchain cell” is applied;

FIG. 2 is a diagram showing a configuration example of an information processing system according to one embodiment of the present invention, which is applied when the service shown in FIG. 1 is provided;

FIG. 3 is a block diagram showing one example of a hardware configuration of a server in the information processing system shown in FIG. 2;

FIG. 4 is a functional block diagram showing one example of a functional configuration of the information processing system including the server with the hardware configuration of FIG. 3;

FIG. 5 is a diagram showing an example where the service shown in FIG. 1 is used to manage devices arranged in the premises;

FIG. 6 is a diagram showing an example of the flow of information processing to undertake measures at high speed in the premises of FIG. 5;

FIG. 7 is a diagram showing an example of the flow of autonomous establishment of processing contents in an input cell of the functional configuration of FIG. 4;

FIG. 8 is a schematic diagram describing one example of the outline of a service to which an “autonomous-decentralized AI blockchain audiovisual cell” is applied;

FIG. 9 is a functional block diagram showing one example of a functional configuration of an information processing system that provides the service of FIG. 8;

FIG. 10 is a diagram showing an example where the service shown in FIG. 7 is used to manage devices arranged in the premises; and

FIG. 11 is a diagram showing an example of the flow of information processing to undertake measures at high speed in the premises of FIG. 10.

### DETAILED DESCRIPTION-PREFERRED MODE FOR CARRYING OUT THE INVENTION

Hereinafter, an embodiment of the present invention will be described with reference to the drawings.

Note that hereinafter, a simple term “image” includes both a “moving image” and a “still image”. Moreover, the “moving image” includes images displayed by the following first to third processing. The first processing indicates processing of continuously switching a series of still images over time to display each movement of an object (e.g., an image of a person or an object targeted for imaging) on a two-dimensional image (2D image). Specifically, for example, the first processing includes two-dimensional animation which is so-called cutoff animation. The second processing indicates processing of setting a motion corresponding to each movement of an object (e.g., an image of a person or an object targeted for imaging) on a three-dimensional image (3D model image) and displaying the motion while changing the motion over time. Specifically, for example, the second processing includes three-dimensional animation. The third processing indicates processing of preparing a video (i.e., moving image) corresponding to each movement of an object (e.g., an image of a natural person) and airing the video over time. Here, the “video (i.e., moving image)” includes a plurality of images (hereinafter referred to as a “unit image(s)”) such as frames or fields.

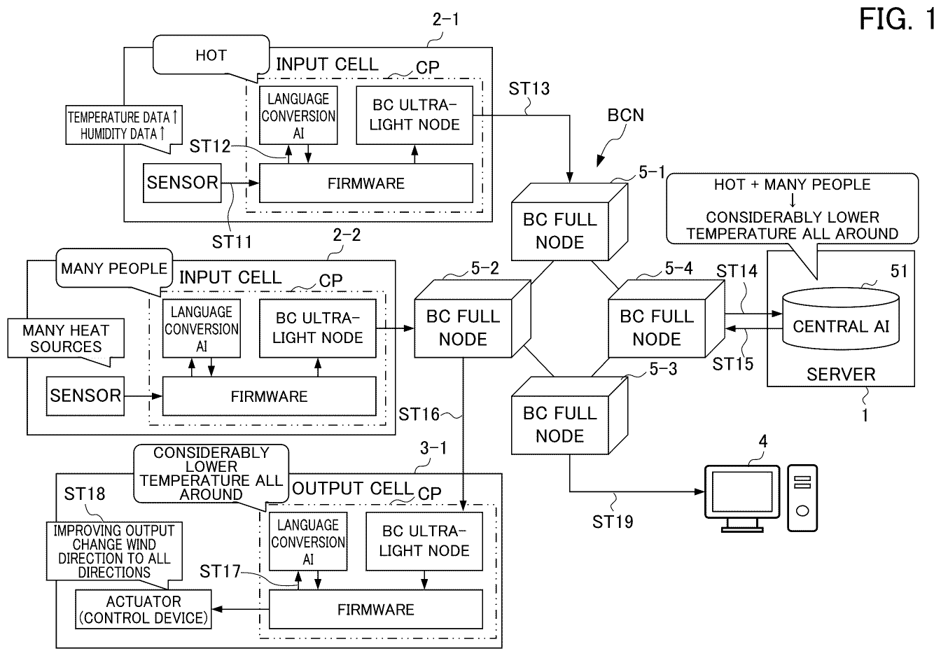

Hereinafter, an “autonomous-decentralized AI blockchain cell” and an “autonomous-decentralized AI blockchain audiovisual cell” which are preconditions for the present invention will be described with reference to FIGS. 1 to 11.

Although details will be described later, a difference between the “autonomous-decentralized AI blockchain cell” and the “autonomous-decentralized AI blockchain audiovisual cell” will be briefly described here. The present service uses, in a facility (e.g., equipment or improvement), a blockchain technique of making output from an output cell (e.g., output cell 3-1 of FIG. 1) by predetermined control according to input from an input cell (e.g., input cells 2-1, 2-2 of FIG. 1).

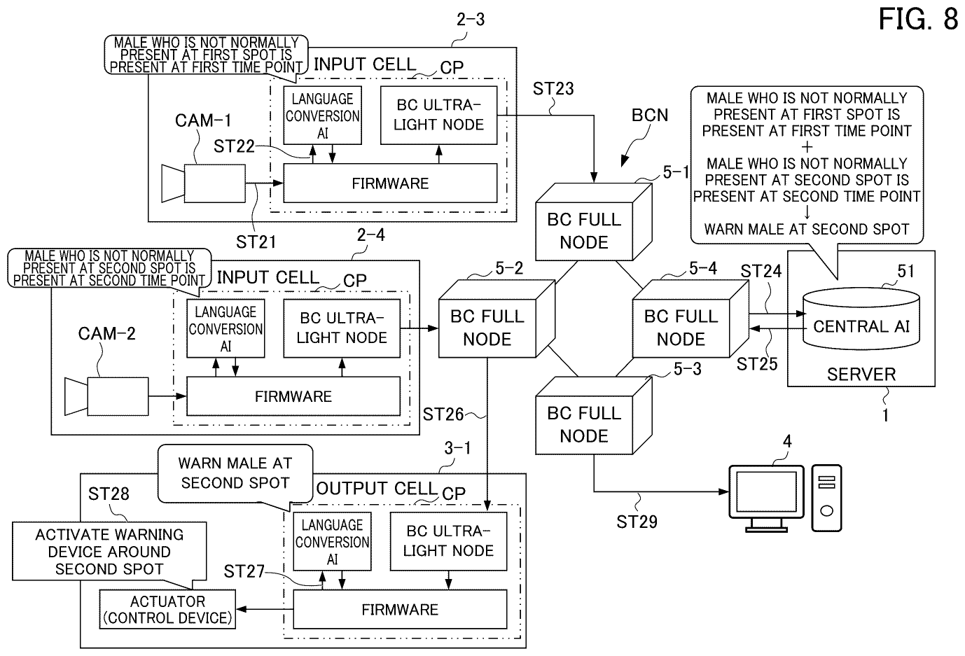

Specifically, the “autonomous-decentralized AI blockchain cell” is configured such that a sensor that measures a physical quantity (e.g., temperature) in a real world is provided in the input cell (e.g., input cell 2-1 of FIG. 1), and a plurality of autonomous-decentralized AI blockchain cells is provided in the equipment and is autonomously operated. On the other hand, the “autonomous-decentralized AI blockchain audiovisual cell” is configured such that a camera that images a predetermined region or a microphone is provided in the input cell (e.g., input cell 2-1 of FIG. 8), and a plurality of autonomous-decentralized AI blockchain audiovisual cells is provided in the equipment and is autonomously operated.

Hereinafter, the “autonomous-decentralized AI blockchain cell” will be described with reference to FIGS. 1 to 7, and the “autonomous-decentralized AI blockchain audiovisual cell” will be described with reference to FIGS. 8 to 11. FIG. 1 is a schematic diagram for describing one example of the outline of a service (hereinafter referred to as a “present service”) to which the “autonomous-decentralized AI blockchain cell” is applied. The present service to which the “autonomous-decentralized AI blockchain cell” is applied provides an information processing system shown in FIG. 1 for making output for operating a control device based on input of data measured by a plurality of sensors.

The information processing system for the present service shown in FIG. 1 includes a server 1, input cells 2-1, 2-2, an output cell 3-1, a checking terminal 4, and blockchain full nodes 5-1 to 5-4 (hereinafter referred to as a “BC full node” as shown in FIG. 1). Although details will be described later, the input cells 2-1, 2-2 and the output cell 3-1 have the function of a blockchain ultra-light node (hereinafter referred to as a “BC ultra-light node” as shown in FIG. 1).

The server 1 is an information processing device including a central AI 61. Although details will be described later, the server 1 acquires, as input data, data obtained by converting measurement results of the sensors in the input cells 2-1, 2-2 into perceptually-expressed data, and outputs, as output data, data perceptually expressed based on the input data in the output cell 3-1 in response to a control instruction.

Each of the input cells 2-1, 2-2 includes the sensor and an autonomous-decentralized chip CP, and converts the measurement result of the sensor into the perceptually-expressed data in the autonomous-decentralized chip CP, and manage the data using a blockchain network BCN.

The output cell 3-1 includes an autonomous-decentralized chip CP and an actuator (one example of the control device), and acquires the control instruction from the server 1 via the blockchain network BCN and controls the control device (actuator) based on the control instruction in the autonomous-decentralized chip CP.

The checking terminal 4 is an information processing device for checking the information managed using the blockchain network BCN. A person in charge of management of the equipment (e.g., factory) can check, e.g., the non-manipulated history of input and output using the checking terminal 4.

Here, the “perceptually-expressed data” will be described. Raw data on the measurement result of the sensor is numerical data and is a physical quantity. Using, e.g., a language, a person can express a result interpreted from the raw data itself on the measurement result of the sensor. Specifically, for example, a person can perceive (recognize, interpret) raw data indicating an air temperature of 35 degrees and a humidity of 80% as hot, and can verbalize such data. Not the raw data on the measurement result of the sensor but the perceptually-expressed (recognized, interpreted) data will be referred to as a “perceptual expression”. Note that the form of the “language” is one example of the form of the perceptual expression. That is, for example, data with a character string of “hot” is data perceptually expressed in the language form of Japanese. For example, in a case where an association with an identifier is made in advance in the information processing device, data on an identifier corresponding to “hot” is also one example of available perceptually-expressed data in the information processing device. Further, for example, moving image data on a movement of fanning the face with a hand can also be taken as data perceptually-expressed in the form of a gesture. Hereinafter, for the sake of simplicity, this description will be made assuming the “perceptual expression” is the “language”.

As described above, the blockchain technique is used for the present service. Generally, the term “blockchain” may mean a distributed ledger technology and a decentralized network. That is, the term “blockchain” is an ambiguous term including a series of data itself in which data called a block is coupled in a chain and a technique and a network related thereto. Thus, hereinafter, a decentralized network that manages the blockchain will be referred to as a “blockchain network” and is differentiated from the “blockchain” which is a series of data in which the blocks are coupled in a chain. That is, the “blockchain” is a series of data in which “blocks” including various types of information (e.g., data itself, metadata, and data related to soundness verification, such as a hash value) on one or more pieces of data (e.g., data based on sensor measurement or data on a device control instruction) managed using the present service are coupled in a chain.

First, the functions of various nodes in the blockchain network BCN in the present service will be described.

The blockchain network BCN includes a plurality of nodes, and at least one of these nodes is present on the cloud. In the example of FIG. 1, each of the four BC full nodes 5-1 to 5-4 functions as a full node on the cloud. Here, the “full node” is an information processing device (node) that provides all the functions of the node in the blockchain, such as a calculation processing function related to block generation and a storage function for the data itself in the blockchain. The BC full nodes 5-1 to 5-4 form the mutually-communicable blockchain network BCN.

In the example of FIG. 1, the BC ultra-light node in each of the two input cells 2-1, 2-2 and the output cell 3-1 functions. Here, the “ultra-light node” is an information processing device (node) that does not provide the calculation processing function related to block generation and the storage function for the data itself in the blockchain, but provides an extremely small number of functions such as a data exchange function with the blockchain network BCN. The ultra-light node is small in, e.g., computational resource necessary for implementation, and therefore, is mounted as part or the entirety of a chip or a program for providing the above-described functions. However, the ultra-light node may be mounted as a separate information processing device.

Note that although not shown in the figure, the node may include a light node. Here, the “light node” is a node which does not function as the full node but carries part of the calculation processing function related to block generation and the storage function for the data itself in the blockchain.

The BC ultra-light nodes in the input cells 2-1, 2-2 and the output cell 3-1 are connected to the cloud via dedicated lines, thereby communicating with the BC full nodes 5-1 to 5-4. That is, in the example of FIG. 1, the four BC full nodes 5-1 to 5-4 and the three BC ultra-light nodes function as seven nodes in total, and accordingly, the blockchain network BCN is formed.

Here, the dedicated line is a communication line only for a particular user. For example, the communication via the dedicated line is isolated from a network (e.g., the Internet) including, e.g., an unreliable information processing device. That is, the communication between the information processing devices connected to each other via the dedicated line has a low probability of being wiretapped or intercepted by, e.g., a malicious third party. That is, the present service is used via the dedicated line, and therefore, is provided with a low probability of the communication being wiretapped or intercepted by, e.g., the third party. Note that the dedicated line is not necessarily physically isolated from, e.g., the Internet. That is, for example, a virtual dedicated line using a virtual private network (VPN) technique may also be employed as the above-described dedicated line.

One example of the configuration of the information processing system for the present service to which the “autonomous-decentralized AI blockchain cell” is applied has been described above with reference to FIG. 1. Hereinafter, details of the flow of information processing in the present service will be described in the order of Steps ST11 to ST19 with reference to FIG. 1.

In Step ST11, numerical data indicating a “temperature increase” and a “humidity increase” is acquired as the measurement result of the sensor of the input cell 2-1. Specifically, for example, numerical data (digital signal) indicating that the temperature has increased from 20 degrees to 40 degrees over time and numerical data (digital signal) indicating that the humidity has increased from 50% to 80% over time are acquired.

In Step ST12, a language conversion AI in the autonomous-decentralized chip CP of the input cell 2-1 converts the digital signal into the language. Specifically, for example, the numerical data (digital signal) indicating that the temperature has increased from 20 degrees to 40 degrees over time and the numerical data (digital signal) indicating that the humidity has increased from 50% to 80% over time are converted into language data with “hot”.

In Step ST13, the BC ultra-light node in the autonomous-decentralized chip CP of the input cell 2-1 manage the language data with “hot” using the blockchain network BCN. Specifically, for example, the BC ultra-light node transmits, as part of transaction in the blockchain technique, the language data with “hot” to the BC full node 5-1, thereby causing the BC full node 5-1 to manage such data. At this time, the BC ultra-light node in the autonomous-decentralized chip CP of the input cell 2-1 manage the encrypted language data using the blockchain network BCN.

Note that although not shown in the figure, the above-described processing of Steps ST11 to ST13 is also executed in the input cell 2-2. Specifically, for example, data indicating that there are many heat sources is acquired as the measurement result of the sensor of the input cell 2-2. Specifically, for example, infrared thermography data is acquired as the data indicating that there are many heat sources. For example, the language conversion AI in the autonomous-decentralized chip CP of the input cell 2-2 converts the data indicating that there are many heat sources into language data with “many people”. For example, the BC ultra-light node in the autonomous-decentralized chip CP of the input cell 2-2 manage the encrypted language data with “many people” using the blockchain network BCN.

In Step ST14, the server 1 decrypts the encrypted language data managed using the blockchain network BCN, and acquires the decrypted language data. In Step ST15, the server 1 manage a result of determination on the contents of the control instruction based on the acquired language data using the blockchain network BCN. Specifically, for example, the server 1 generates, as output data, language data with a control instruction of “considerably lower the temperature all around” using the educated central AI 61, which is an AI that performs natural language processing, with the language data with “hot” and “many people” as the input data. The server 1 manage the generated control instruction of “considerably lower the temperature all around” using the blockchain network BCN. At this time, the server 1 manage the encrypted control instruction using the blockchain network BCN.

In Step ST16, the BC ultra-light node in the autonomous-decentralized chip CP of the output cell 3-1 acquires the encrypted control instruction managed using the blockchain network BCN.

In Step ST17, firmware in the autonomous-decentralized chip CP of the output cell 3-1 decrypts the encrypted control instruction. Then, the language conversion AI in the autonomous-decentralized chip CP of the output cell 3-1 converts the control instruction into a digital signal indicating specific contents of control of the control device. Specifically, for example, the language conversion AI in the autonomous-decentralized chip CP of the output cell 3-1 converts the control instruction of “considerably lower the temperature all around” into a digital signal causing the control device to “improve the output” of cooling by an air-conditioner and “change wind direction to all directions”. That is, for example, the language conversion AI in the autonomous-decentralized chip CP of the output cell 3-1 outputs a control signal (digital signal) which is digital data for operating the actuator for performing cooling by the air-conditioner. Note that although not shown in the figure, the BC ultra-light node in the autonomous-decentralized chip CP of the output cell 3-1 can also cause the BC full node to manage the control device operation of “improving the output” of cooling by the air-conditioner and “changing the wind direction to all directions” using the blockchain network BCN.

In Step ST18, the actuator (one example of the control device) is driven according to the control signal (digital signal) which is the digital data for operating the actuator for performing the cooling in “all wind directions” with the “improved output” by the air-conditioner. As a result, the actuator (one example of the control device) is operated according to the control instruction of “considerably lower the temperature all around” from the central AI 61. In this manner, a setting of “improving the output” of the cooling by the not-shown air-conditioner and “changing the wind direction to all directions” is made based on the measurement results of the sensors, such as the “temperature increase”, the “humidity increase”, and the “many heat sources”, and environment is improved accordingly.

In Step ST19, the checking terminal 4 can provide a manager of the equipment (e.g., factory) with the information managed using the blockchain network BCN. That is, the manager of the equipment (e.g., factory) can check the information provided to the checking terminal 4, which includes the measurement results of the sensors, such as the “temperature increase”, the “humidity increase”, and the “many heat sources” acquired by the sensors, the input data (language data) such as the “hot” and the “many people”, the output data (language data) with the control instruction of “considerably lower the temperature all around”, and the control device operation of “improving the output” of the cooling by the air-conditioner and “changing the wind direction to all directions”. These types of information are managed using the blockchain network BCN, and therefore, are provided as, e.g., the non-manipulated history of input and output to the manager of the equipment (e.g., factory).

With the above-described configuration and operation, the present service has the following characteristics. First, the existing AI educated with the language can be employed as the central AI 61. That is, in the present service, the existing AI educated with the language can be used as the central AI 61, and therefore, a development cost and an operation cost can be reduced as a whole. Specifically, in a case where this system is newly built in the equipment, the sensor to be used varies according to the equipment, and assumed environment also varies. For this reason, the value of the measurement result of the sensor also varies, and therefore, e.g., learning is necessary for the AI according to the equipment. However, the AI capable of performing the natural language processing of generating the input data (language data) such as the “hot” and the “many people” and the output data (language data) with the control instruction of “considerably lower the temperature all around” has been used for many purposes, and therefore, various developments have been made thereon. Thus, under current circumstances, the accuracy of such an AI capable of performing the natural language processing has improved, and the cost has decreased. As a result, in the present service, the development cost and the operation.

Second, the AI processing is performed on the edge side, and therefore, the burden of the processing using the central AI 61 is reduced. That is, in the present service, in the input cells 2-1, 2-2 (edge side), the processing of converting the sensor measurement results into the language data (one example of the perceptual expression) is performed. In the output cell 3-1 (edge side), the processing of converting the language data (output data with the control instruction) into the digital signal indicating the specific contents of control of the control device is performed. In other words, the central AI 61 does not need to perform these types of processing, and therefore, the burden is reduced. That is, it can be said that the decentralized AI processing is implemented. The effect of this decentralized processing becomes more prominent as the number of input cells and the number of output cells on the edge side increase.

Third, in the present service, the data is ensured using the blockchain network BCN, and therefore, a safe AI system is implemented. That is, for example, in a system using no blockchain network BCN, there is a probability that a fake input cell 2-1 inputs language data with a “temperature decrease” to the central AI 61 and an erroneous control instruction is output accordingly. In the present service, the data is ensured using the blockchain network BCN, and therefore, it is impossible for the fake input cell 2-1 to operate and the safe AI system can be implemented.

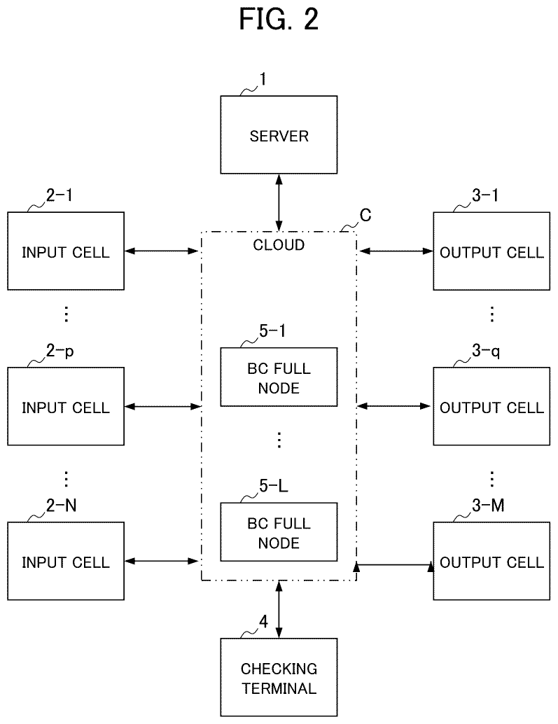

The outline of the present service has been described above with reference to FIG. 1. Hereinafter, the information processing system applied when the service shown in FIG. 1 is provided as the present service will be described with reference to FIGS. 2 to 4. FIG. 2 is a diagram showing a configuration example of the information processing system according to one embodiment of the present invention, which is applied when the service shown in FIG. 1 is provided.

That is, the configuration example of the information processing system shown in FIG. 2 is a more general system configuration of the information processing device for the present service of FIG. 1.

The server 1 is an information processing device managed by a service provider S. The server 1 executes various types of processing for implementing the present service while communicating as necessary with input cells 2-1 to 2-N (N is an integer of one or more), output cells 3-1 to 3-M (M is an integer of one or more, which is independent of N), a checking terminal 4, BC full nodes 5-1 to 5-L (L is an integer of one or more, which is independent of N and M).

The input cells 2-1 to 2-N are information processing devices including one or more sensors and autonomous-decentralized chips CP. When one of the N input cells 2-1 to 2-N is described with reference to the figure, an “input cell 2-p” (p is an integer of one or more and N or less) is used.

The output cells 3-1 to 3-M are information processing devices including one or more control devices and autonomous-decentralized chips CP. When one of the M output cells 3-1 to 3-M is described with reference to the figure, an “output cell 3-q” (q is an integer of one or more and M or less) is used.

The checking terminal 4 is an information processing device allowing the person in charge of management of the facility (e.g., factory) to check the information managed using the blockchain network BCN. Note that one checking terminal 4 is shown in FIG. 2, but the number of checking terminals 4 may be arbitrary.

The BC full nodes 5-1 to 5-L are information processing devices (nodes) that provide all the functions of the node in the blockchain, such as the calculation processing function related to block generation and the storage function for the data itself in the blockchain. The BC full nodes 5-1 to 5-L of the example of FIG. 2 are present on the cloud C.

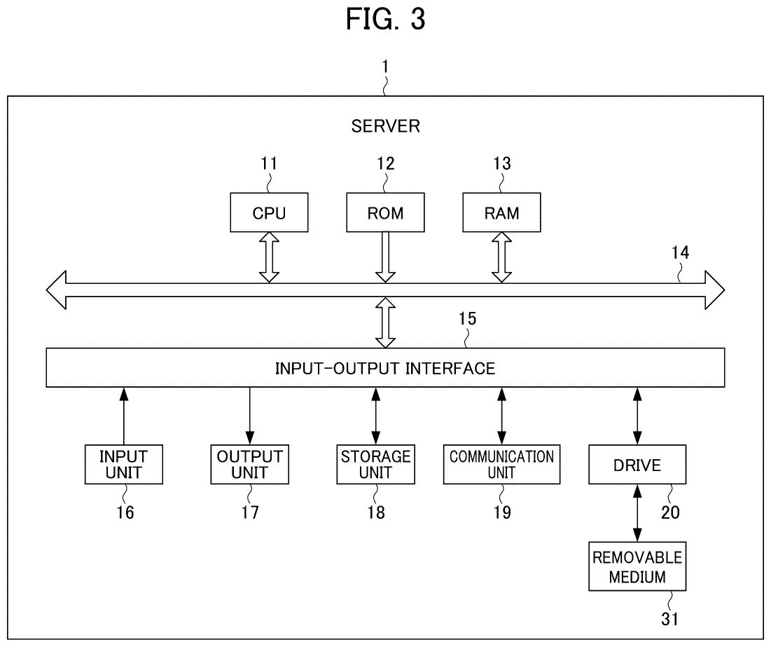

FIG. 3 is a block diagram showing one example of a hardware configuration of the server in the information processing system shown in FIG. 2.

The server 1 includes a central processing unit (CPU) 11, a read only memory (ROM) 12, a random access memory (RAM) 13, a bus 14, an input-output interface 15, an input unit 16, an output unit 17, a storage unit 18, a communication unit 19, and a drive 20.

The CPU 11 executes various types of processing according to programs recorded in the ROM 12 or programs loaded into the RAM 13 from the storage unit 18. The RAM 13 also stores, e.g., data necessary for executing various types of processing by the CPU 11, as necessary.

The CPU 11, the ROM 12, and the RAM 13 are connected to each other via the bus 14. Moreover, the input-output interface 15 is also connected to the bus 14. The input unit 16, the output unit 17, the storage unit 18, the communication unit 19, and the drive 20 are connected to the input-output interface 15.

The input unit 16 includes, for example, a keyboard, and various types of information are input via the input unit 16. The output unit 17 includes, for example, a display such as a liquid crystal display and a speaker, and outputs various types of information as an image or sound. The storage unit 18 includes, for example, a dynamic random access memory (DRAM), and stores various types of data. The communication unit 19 communicates with other devices (e.g., the input cells 2-1 to 2-N, the output cells 3-1 to 3-M, the checking terminal 4, and the BC full nodes 5-1 to 5-L in FIG. 2) via a network including the Internet.

A removable medium 31 including, e.g., a magnetic disk, an optical disk, a magnetic optical disk, and a semiconductor memory is attached as necessary to the drive 20. The program read from the removable medium 31 by the drive 20 is installed as necessary in the storage unit 18. Moreover, the removable medium 31 can also store, as in the storage unit 18, various types of data stored in the storage unit 18.

Note that although not shown in the figure, the input cells 2-1 to 2-N, the output cells 3-1 to 3-M, the checking terminal 4, and the BC full nodes 5-1 to 5-L of FIG. 2 can also have configurations basically similar to the hardware configuration shown in FIG. 3. Thus, description of the hardware configurations of the input cells 2-1 to 2-N, the output cells 3-1 to 3-M, the checking terminal 4, and the BC full nodes 5-1 to 5-L are omitted. Note that the input cells 2-1 to 2-N include sensors as input units, as shown in FIG. 1. Moreover, the input cells 2-1 to 2-N have, as autonomous-decentralized chips CP, part or the entirety of, e.g., CPUs, ROMs, and RAMs. Similarly, the output cells 3-1 to 3-M include control devices (e.g., actuators) as output units, as shown in FIG. 1. Moreover, the output cells 3-1 to 3-M have, as autonomous-decentralized chips CP, part or the entirety of, e.g., CPUs, ROMs, and RAMs.

Various types of processing can be executed by cooperation of various types of hardware of the server 1 of FIG. 3 and various types of software. As a result, the above-described present service can be provided. Hereinafter, a functional configuration of the information processing system of FIG. 2 including the server 1 of the FIG. 3 will be described.

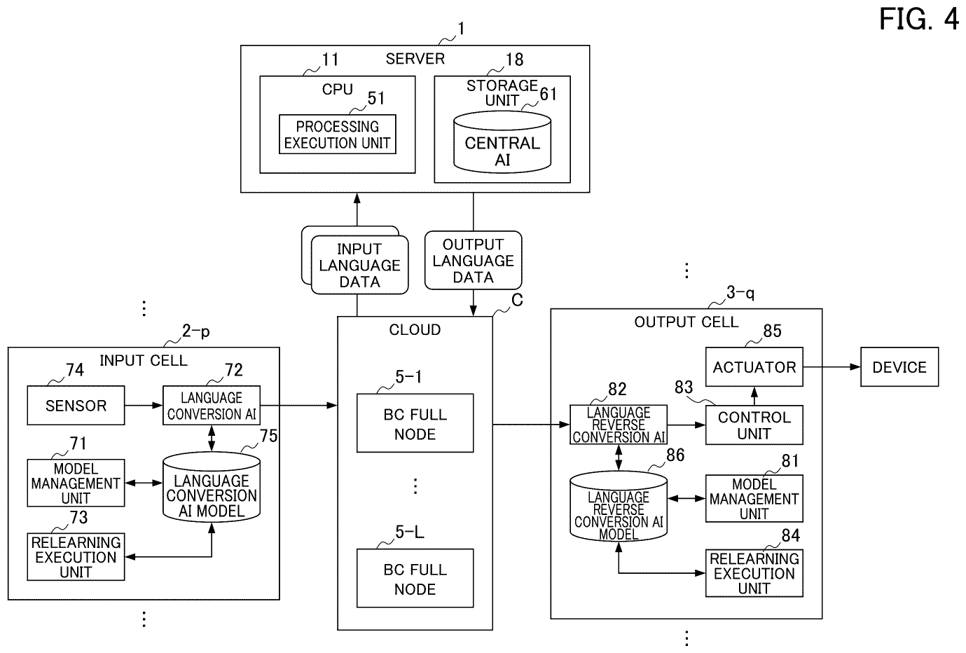

FIG. 4 is a functional block diagram showing one example of the functional configuration of the information processing system including the server with the hardware configuration of FIG. 3.

As shown in FIG. 4, in the CPU 11 of the server 1, a processing execution unit 51 functions. The storage unit 18 stores a model of the central AI 61.

In the input cell 2-p, a model management unit 71, a language conversion AI 72, a relearning execution unit 73, and a sensor 74 function as the autonomous-decentralized chip CP. The input cell 2-p has the sensor 74 as an input unit. Moreover, the storage unit of the input cell 2-p stores a language conversion AI model 75.

In the output cell 3-q, a model management unit 81, a language reverse conversion AI 82, a control unit 83, and a relearning execution unit 84 function as the autonomous-decentralized chip CP. The output cell 3-1 has an actuator 85 as an output unit. Moreover, the storage unit of the output cell 3-q stores a language reverse conversion AI model 86.

The processing execution unit 51 acquires, as input data, input language data from one or more input cells 2-p, executes predetermined processing using the input data, and outputs, as output data, one or more pieces of output language data indicating a processing execution result. The processing execution unit 51 acquires the stored input data using the blockchain network BCN.

The model management unit 71 manages the language conversion AI model 75 for receiving a signal indicating a measurement result of the sensor 74, converting the signal into language data, and outputting the language data with the language conversion AI model 75 stored in the storage unit. Specifically, for example, the model management unit 71 converts a measurement result such as a temperature, a humidity, or a thermography measurement into language data such as a “temperature increase”, a “humidity increase”, or “many people”, and outputs such language data.

The language conversion AI 72 acquires, from the sensor 74 that detects a predetermined physical quantity in a real world, a signal indicating the predetermined physical quantity, inputs the signal to the language conversion AI model 75, and outputs language data from such a model as at least part of input language data for the server 1.

The relearning execution unit 73 executes relearning for updating the model.

The BC ultra-light node of the input cell 2-p store at least part of the input language data from the language conversion AI 72 using the blockchain network BCN.

The model management unit 81 manages the language reverse conversion AI model 86 for receiving language data, converting the language data into a predetermined physical quantity, and outputting the physical quantity with the language reverse conversion AI model 86 stored in a predetermined storage medium.

The BC ultra-light node of the output cell 3-q acquires output language data stored using the blockchain network BCN and provides the output language data to the language reverse conversion AI 82. The language reverse conversion AI 82 acquires at least part of one or more pieces of language expression data forming output data from the server 1, and inputs such data to the language reverse conversion AI model 86, and such a model outputs a signal indicating a physical quantity accordingly.

The control unit 83 inputs, as an instruction signal, the signal output from the model and indicating the physical quantity to the actuator 85, thereby controlling the actuator 85.

The relearning execution unit 84 executes relearning for updating the model.

Note that an example of the relearning by the relearning execution unit 73 and the relearning execution unit 84 will be described later. With this functional configuration, the information processing system for the present service can execute each type of processing described with reference to, e.g., FIG. 1.

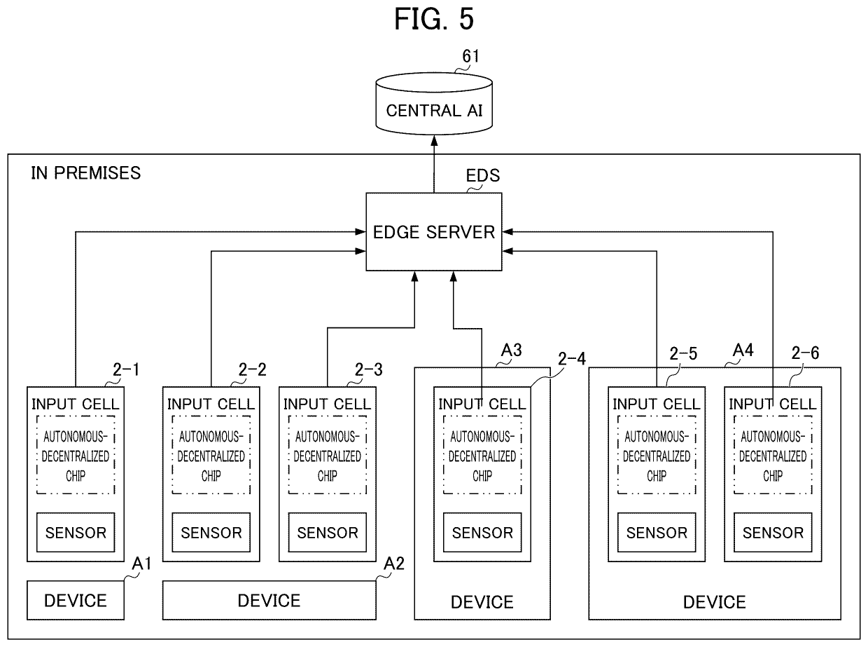

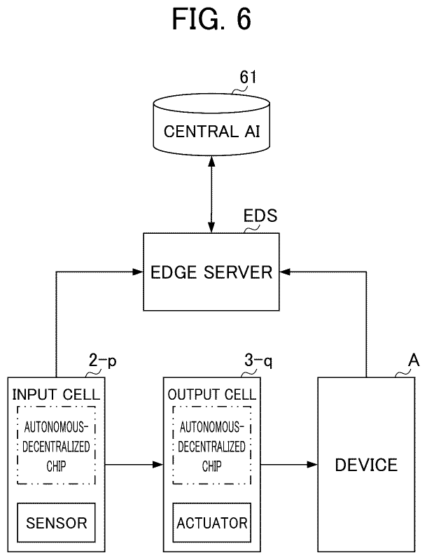

Further, the information processing system of the present embodiment may be used as follows. Hereinafter, an example where the present information processing system is applied and used to monitor a plurality of devices arranged in the premises will be described with reference to FIGS. 5 and 6. FIG. 5 shows a diagram showing an example where the service shown in FIG. 1 is used to manage devices arranged in the premises. In the example of FIG. 5, four devices A1 to A4 are arranged in the premises. That is, for example, the devices A1 to A4 are devices arranged on a manufacturing line in the premises such as a factory.

The input cell 2-1 is disposed for the device A1. This shows, for example, a state in which the sensor of the input cell 2-1 measures an event related to the device A1 on the manufacturing line. Specifically, for example, the sensor measures an arbitrary physical quantity such as the temperature of a predetermined portion of the device A1 or the weight of a material injected into the device A1.

The input cells 2-2, 2-3 are arranged for the device A2. This shows a state in which the sensors of the two input cells 2-2, 2-3 measure two physical quantities of one device A2. That is, although the sensor of one input cell 2-1 measures the physical quantity of one device A1 in the device A1, the plurality of input cells can be arranged for one device.

The input cell 2-4 is disposed in the device A3. This shows a state in which the input cell 2-4 is built in the device A3 and the sensor of the input cell 2-4 measures the physical quantity of the device A3.

The input cells 2-5, 2-6 are arranged in the device A4. This shows a state in which the two input cells 2-5, 2-6 are built in one device A4 and the sensors of the two input cells 2-5, 2-6 measure the physical quantities of the device A4.

Each of the input cells 2-1 to 2-6 converts data measured by the sensor into language data, and transmits the language data to an edge server EDS. In this manner, the data on the plurality of devices A1 to A4 in the premises is collected.

With this configuration, e.g., breakdown can be detected/predicated from the operation statuses of various devices (e.g., manufacturing robot (line), room temperature control, and lighting control) used in the premises. Further, unmanned monitoring in the premises (e.g., factory, hospital, or condominium) shown in FIG. 5 can be performed. As described above, in a conventional monitoring system, in a case where, e.g., an accident has occurred and data (abnormal values) is transmitted at once from many sensors, a central monitoring device sequentially performs the processing, and for this reason, it may take considerable time to undertake measures, such as outputting an alarm to a user (e.g., guard) or operating emergency equipment (e.g., fire extinguishing by a sprinkler).

On the other hand, in the present information processing system, each input cell performs the conversion into the language data, and therefore, the processing can be decentralized and the measures can be taken at high speed as a whole.

Further, the processing is performed with no control instruction from the central AI 61, and therefore, measures can be taken at higher speed. FIG. 6 is a diagram showing an example of the flow of information processing when measures are taken at higher speed in the premises of FIG. 5. In the example of FIG. 6, language data is provided from the input cell 2-p to the output cell 3-q. That is, the language data from the input cell 2-p may be provided to the output cell 3-q without the central AI 61. The input cell 2-p and the output cell 3-q preferably have the following basic logics in the “autonomous-decentralized AI blockchain cell”.

First, the input cell 2-p and the output cell 3-q preferably have an “individuality establishment logic”. That is, the “individuality establishment logic” is a logic processing algorithm separately included and established in the input cell 2-p and the output cell 3-q according to, e.g., a sensor measurement target. That is, for example, drive devices such as motors have manufacturing tolerances and are individually degraded over time. Specifically, for example, even in the case of motors of the same type, some motors cause vibration and abnormal overheating at 1000 rpm (revolutions per minute), and other motors normally rotate even at 2000 rpm. Each of the input cells 2-p that quickly produce various elements (physical quantities) by the sensors attached to the motors individually learns the individuality of the motor managed by the input cell 2-p itself, and can set a normal line limit by itself. When the physical quantity exceeds the limit individually set by the input cell 2-p itself, the input cell 2-p can provide language data with an “abnormal motor rotation speed”. Note that for, e.g., the stable operation temperature of a control board other than the motor, the individuality establishment logic can be similarly applied.

Second, the input cell 2-p and the output cell 3-q preferably have a “comparison-to-other learning logic”. That is, the “comparison-to-other learning logic” is an algorithm for grasping, based on a result of information exchange with other cells, what type of individuality a device managed by a cell itself has as compared to other devices. Specifically, each of the input cell 2-p and the output cell 3-q can grasp what type of individuality the device (sensor measurement target or target to be controlled via the control device) managed by the cell itself has as compared to other devices by sharing data with the other cells. With this configuration, output information can be corrected using the shared data. That is, the language conversion AI model 75 of the input cell 2-p executes, by the relearning execution unit 73, relearning processing based on language data from other input cells. That is, for example, with reference to the example of FIG. 1, it is assumed that language data with “few people” is output, but many input cells including another input cell 2-2 output language data with “many people”. In this case, it is assumed that in spite of the same region targeted for sensor monitoring, the input cell 2-p outputs the language data with “few people”. In this case, the relearning execution unit 73 of the input cell 2-p can perform the relearning processing such that the output of “many people” is more easily output. As described above, the input cell 2-p can perform the learning based on (as compared to) the language data output from other input cells (others).

Third, the input cell 2-p and the output cell 3-q preferably have a “consciousness communication logic”. The “consciousness communication logic” is a logic algorithm for the language conversion AI of the input cell 2-p outputting a human language expressing human consciousness and intention at the same time as the output of digital data as normal sensor output. Specifically, for example, the language conversion AI 72 of the input cell 2-p outputs language data with, e.g., “it is a little hot”, “I feel a lot of vibrations”, or “it's a dangerous situation”. The central AI 61 which is the existing language input AI directly grasps such language data, and therefore, can think and make a determination. That is, in an urgent situation, the edge server EDS of FIG. 6 can undertake measures without waiting for a determination result from the high-order server 1 outside the premises at the same time as notification to the server 1 (not shown in FIG. 6, the server 1 shown in, e.g., FIG. 4) outside the premises.

Fourth, the input cell 2-p and the output cell 3-q preferably have a “self-measures logic”. In a case where it is not necessary to ask the central monitoring device for a determination, such as a case where a distinct abnormality has been detected, the present information processing system can undertake measures without waiting for a response from the edge server EDS or the not-shown server 1. Specifically, for example, in a case where the input cell 2-p outputs not language data with a “temperature increase” but language data with “fire has occurred”, such language data is provided to the output cell 3-q so that an alarm can be sounded or a sprinkler can be activated locally. That is, in a case where the central AI 61 is assumed as the human brain, the present information processing system can undertake measures as in reflex without waiting for a determination from the brain. With this configuration, the information processing is implemented to undertake measures at high speed.

Fifth, the input cell 2-p and the output cell 3-q preferably have an “ethical logic”. That is, by the ethical logic, the edge server EDS or the not-shown server 1 outside the premises can make a prediction or determination as a whole, output language data for control instruction, and educate each cell. That is, the language conversion AI model 75 of the input cell 2-p executes, by the relearning execution unit 73, the relearning processing based on, e.g., output language data from the central AI 61. By such learning, the input cell 2-p can output not the language data with the “temperature increase” but the higher-order language data with the “fire has occurred”. Thus, according to a processing stage in the input cell 2-p, the input cell 2-p can individually make a determination and instantaneously undertake measures. As a result, a serious accident can be prevented in advance. That is, the information processing is implemented to undertake measures at high speed.

As described above, the input cell 2-p and output cell 3-q of the present information processing system makes, by IT, the concept of an identity a reality, and is configured as the so-called “autonomous-decentralized AI blockchain cell”.

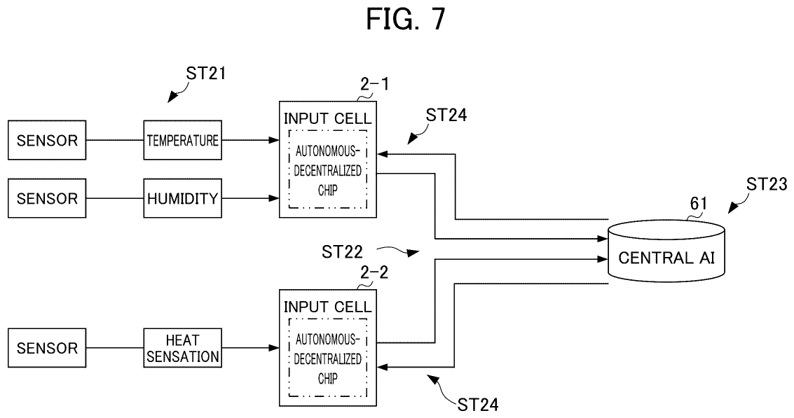

Further, as the “autonomous-decentralized AI blockchain cell”, the input cell 2-p and output cell 3-q of the present information processing system can autonomously determine the processing contents and request the central AI 61 for the instruction for the processing contents. FIG. 7 is a diagram showing an example of the flow of autonomous establishment of the processing contents in the input cell in the functional configuration of FIG. 4.

As shown in Step ST21, the input cell 2-1 shown in FIG. 7 acquires temperature information from a first sensor and humidity information from a second sensor. At this time, the autonomous-decentralized chip of the input cell 2-1 autonomously recognizes the “mission” of the input cell 2-1 based on the information acquired from the sensors. Here, the mission indicates the processing contents to be performed by the input cell 2-1 and includes specific processing contents indicating what type of language data needs to be output based on the temperature information and the humidity information. That is, for example, the input cell 2-1 identifies, based on a data form, that the acquired data is the temperature and humidity information, and determines that the mission thereof is for determining temperature (humidity) environment. Similarly, in the input cell 2-2, as a result of acquiring a heat sensation (e.g., thermography data) from the sensor, the input cell 2-2 determines that the mission thereof is for determining the density of heat sources (density of people particularly in the example of FIG. 1). As described above, the input cells 2-1, 2-2 can autonomously recognize the missions of the cells themselves.

As shown in Step ST22, the input cells 2-1, 2-2 transmit the missions of the cells themselves to the central AI 61.

As shown in Step ST23, the central AI 61 determines the missions transmitted from each cell in a comprehensive manner and can determine whether or not the mission of each cell is reasonable. The central AI 61 determines whether or not the mission autonomously recognized by each cell is reasonable. Then, the central AI 61 transmits information on the (correct) mission in a case where the mission autonomously recognized by each cell is not reasonable. As a supplemental note, the central AI 61 can also perform various types of determination processing in addition to the determination processing for outputting the output language data based on the input language data described above. Specifically, for example, an image of the entirety of the equipment and information on planned arrangement of the input cells 2-p are stored in advance, and processing of making a comprehensive determination based on the information from the input cells can be performed.

As shown in Step ST24, the autonomously-recognized mission and the information on the (correct) mission from the central AI 61 are compared to each other, and the mission of the cell itself is finally determined. Then, the input cells 2-1, 2-2 execute the subsequent processing based on the finally-determined missions.

As a summary of the description above, the input cells 2-1, 2-2 can recognize the missions of the cells themselves based on the information from the sensors. With this configuration, the individualities of the input cells 2-1, 2-2 are established, and operate as cells only for these sensors. When connected to the sensors and acquiring the information from the sensors, the input cells 2-1, 2-2 recognize the missions thereof, and therefore, can be produced and shipped in a neutral state without, e.g., individual setting. Thus, a cost for producing the input cells 2-1, 2-2 can be reduced.

The embodiment of the “autonomous-decentralized AI blockchain cell” has been described above, but the “autonomous-decentralized AI blockchain cell” is not limited to that of the above-described embodiment and changes, modifications, etc. can be made within a scope in which the object of the present invention can be accomplished.

In the above-described embodiment, the input cell 2-p generates the language data from the sensor measurement value, but the present invention is not particularly limited thereto. That is, for example, in a case where the input cell 2-p has a function of converting a “language” for humans into a “language” for machines and a “temperature increase” in the human language is associated in advance with an identifier in the information processing device, the input cell 2-p may convert such a “language” into an identifier corresponding to “hot”. With this configuration, a result of checking with, e.g., human eyes can also be employed as the input language data in the present information processing system.

For example, the sensor may be a microphone or a camera. That is, for example, the language conversion AI 72 may identify a person from sound acquired by the microphone and output the sound as language data, or may identify a feeling of this person and output such a felling as language data. For example, the language conversion AI 72 may convert a gesture of a person in a moving image acquired by the camera into language data.

As described above, the “autonomous-decentralized AI blockchain cell” is the unit of the information processing device capable of executing, using the sensor function, the processing related to the sensors for, e.g., a temperature, a humidity, a pressure, a vibration, an altitude, a sound pressure, a luminance, an ultrasonic wave, a voltage, and a current and the blockchain. Note that the information processing device is not limited to the personal computer or the server device and can be implemented as a chip which is an electronic component. Thus, the information processing device can be easily incorporated into conventional various devices.

Next, an embodiment including the “autonomous-decentralized AI blockchain audiovisual cell”, i.e., the input cell including the camera, will be described hereinafter with reference to FIGS. 8 to 11. Note that for distinguishing the input cell including the camera from the above-described “input cell 2-p”, such an input cell will be particularly referred to as an “input cell 2-r” (r is an integer of one or more and N or less other than p).

That is, as conventional unmanned monitoring in the premises (e.g., factory, hospital, or condominium), i.e., monitoring with no person in the premises, monitoring for a security reason is performed in the premises, or various devices used in the premises are monitored. Specifically, a captured image is recorded in a recorder and a person monitors such an image, and in this manner, a suspicious person is detected and breakdown is detected or predicted. Thus, since the person is involved, there is a delay in undertaking measures even in a case where an instantaneous determination is required, such as an unexpected incident or accident, leading to a major disaster.

For example, conventionally for person detection such as detection of a roaming suspicious person or detection of a person who has engaged in dangerous behavior once and is doing a similar thing again, a method of a person (human) in charge making a determination while viewing an image from a monitoring camera or checking an image recorded in a recorder has been used. For detection of an event in which a suspicious person is roaming in an area only for authorized people or a person who has engaged in dangerous behavior once and is doing a similar thing again, a person in charge who knows what has happened so far makes a determination while viewing an image from a monitoring camera, or checks a recorded video after, e.g., a report of the suspicious person being detected. As described above, for determination by a person in charge, there is a possibility that there is a delay in undertaking measures due to, e.g., the need to check an image from each monitoring camera, which could increase the extent of damage due to an accident.

Conventionally, there has been an automatic fire detection device using, e.g., a heat sensor or a smoke sensor. However, such a conventional automatic fire detection device detects fire after the occurrence thereof. That is, the conventional automatic fire detection device cannot detect an abnormality before the occurrence of fire, and cannot undertake measures in advance based on the predicted occurrence of fire. That is, for example, in an accident such as a fire, the automatic detection device using, e.g., the heat sensor or the smoke sensor can detect fire after the occurrence thereof. However, the automatic detection device cannot detect an abnormality in advance, and it is impossible for the automatic detection device to undertake measures in advance based on prediction. For this reason, there has been demanded a system which is capable of more quickly starting to undertake measures and is available without a large centralized system.

The “autonomous-decentralized AI blockchain audiovisual cell” contributes to providing a system that more suitably processes data on images captured by a plurality of cameras.

Hereinafter, an embodiment of the present invention will be described with reference to the drawings.

FIG. 8 is a schematic diagram describing one example of the outline of the present service to which the “autonomous-decentralized AI blockchain audiovisual cell” is applied. The present service to which the “autonomous-decentralized AI blockchain audiovisual cell” is applied provides an information processing system shown in FIG. 8 for making output for operating a control device based on input of data on images captured by a plurality of cameras. Note that for distinguishing the input cells including the cameras from the input cell in the description of FIG. 1, these cells will be described using reference numerals 2-3, 2-4 in FIG. 8.

The information processing system for the present service shown in FIG. 8 includes a server 1, input cells 2-3, 2-4, an output cell 3-1, a checking terminal 4, and blockchain full nodes 5-1 to 5-4 (hereinafter referred to as a “BC full node” as shown in FIG. 1). Although details will be described later, the input cells 2-3, 2-4 and the output cell 3-1 have the function of a blockchain ultra-light node (hereinafter referred to as a “BC ultra-light node” as shown in FIG. 1).

The server 1 is an information processing device including a central AI 61. Although details will be described later, the server 1 acquires, as input data, data obtained by converting data on an image captured by each of cameras CAM-1, CAM-2 of the input cells 2-3, 2-4 into perceptually-expressed data, and outputs, as output data, data perceptually expressed based on the input data by the output cell 3-1 in response to a control instruction.

Each of the input cells 2-3, 2-4 includes the camera CAM-1, CAM-2 and an autonomous-decentralized chip CP, and converts the data on the image captured by the camera into the perceptually-expressed data in the autonomous-decentralized chip CP, and manage the data using a blockchain network BCN.

The output cell 3-1 includes an autonomous-decentralized chip CP and an actuator (one example of the control device), and acquires the control instruction from the server 1 via the blockchain network BCN and controls the control device (actuator) based on the control instruction in the autonomous-decentralized chip CP.

The checking terminal 4 is an information processing device for checking the information managed using the blockchain network BCN. A person in charge of management of the equipment (e.g., factory) can check, e.g., the non-manipulated history of input and output using the checking terminal 4.

Here, a specific example of the “perceptually-expressed data” on the image captured by the camera will be described. The data (raw data) on the images captured by the plurality of cameras is, for example, numerical data on the color of each pixel arranged two-dimensionally in the case of a still image. Using, e.g., a language, a person can express a result interpreted from these images. Specifically, for example, in the case of an image of a first spot, if a certain male image is shown for the first time at a first time point even though the image has not been shown up until the first time point (e.g., over several months), a person who saw (viewed) such an image can perceive (recognize, interpret) that the male who is not normally present at the first spot is present at the first time point, and can verbalize such data. Not the image data (raw data) but the perceptually-expressed (recognized, interpreted) data will be referred to as a “perceptual expression”. Note that the form of the “language” is one example of the form of the perceptual expression. That is, for example, data with a character string of “kaji (fire)” is data perceptually expressed in the language form of Japanese. For example, in a case where an association with an identifier is made in advance in the information processing device, data on identifiers corresponding to the “first spot” and the “fire” is also one example of available perceptually-expressed data in the information processing device. Further, for example, data on a still image of a fire icon can also be taken as data perceptually-expressed in the form of an icon corresponding to the “fire”.

First, the functions of various nodes in the blockchain network BCN in the present service of FIG. 8 are basically similar to those of FIG. 1. Moreover, in the example of FIG. 8, the function of the BC ultra-light node in each of the two input cells 2-3, 2-4 and the output cell 3-1 is also basically similar to that of FIG. 1. Thus, description thereof will be omitted.

One example of the configuration of the information processing system for the present service to which the “autonomous-decentralized AI blockchain audiovisual cell” is applied has been described with reference to FIG. 8. Hereinafter, details of the flow of information processing in the present service will be described in the order of Steps ST21 to ST29 with reference to FIG. 8.

In Step ST21, the camera CAM-1 in the input cell 2-3 captures an image of the first spot at the first time point. Then, as data on the image captured by the camera CAM-1, data on an “image including a certain male image” is acquired.

In Step ST22, the language conversion AI in the autonomous-decentralized chip CP of the input cell 2-3 converts the image data (digital signal) into a language. Here, for example, it is assumed that the male image included in the image has not been captured before the first time point. In this case, the image data (digital signal) is converted into language data with “the male who is not normally present at the first spot is present at the first time point”.

In Step ST23, the BC ultra-light node in the autonomous-decentralized chip CP of the input cell 2-3 manage the language data with “the male who is not normally present at the first spot is present at the first time point” using the blockchain network BCN. Specifically, for example, the BC ultra-light node transmits, as part of transaction in the blockchain technique, the language data with “the male who is not normally present at the first spot is present at the first time point” to the BC full node 5-1, thereby causing the BC full node 5-1 to manage such data. At this time, the BC ultra-light node in the autonomous-decentralized chip CP of the input cell 2-3 manage the encrypted language data using the blockchain network BCN. Note that at this time, the feature (e.g., features such as a height, a physique, and clothes) of the male may be managed as necessary. The captured image data itself may also be managed as necessary using the blockchain network BCN. Specifically, for example, metadata of the image data is managed using the blockchain network BCN. The image data itself is encrypted or divided as necessary, and is managed using, e.g., an IPFS.

Although not shown in the figure, processing similar to that of Steps ST21 to ST23 above is also executed in the input cell 2-4. Specifically, for example, the camera CAM-2 in the input cell 2-4 captures an image of a second spot at a second time point after the first time point. Then, as data on the image captured by the camera CAM-2, data on an “image including a certain male image” is acquired. Then, the language conversion AI in the autonomous-decentralized chip CP of the input cell 2-4 converts the image data (digital signal) into a language. Here, for example, it is assumed that the male image included in the image has not been captured before the first time point. In this case, the image data (digital signal) is converted into language data with “the male who is not normally present at the second spot is present at the second time point”. Then, the BC ultra-light node in the autonomous-decentralized chip CP of the input cell 2-4 manage the encrypted language data with “the male who is not normally present at the second spot is present at the second time point” using the blockchain network BCN.

In Step ST24, the server 1 decrypts the encrypted language data managed using the blockchain network BCN and acquires the decrypted language data. In Step ST25, based on the acquired language data, the server 1 manages a result of determination on the contents of the control instruction using the blockchain network BCN. Specifically, for example, the server 1 generates, as output data, language data with a control instruction of “warn the male at the second spot” using the educated central AI 61, which is an AI that performs the natural language processing, with the language data with “the male who is not normally present at the first spot is present at the first time point” and “the male who is not normally present at the second spot is present at the second time point” as input data. The server 1 manage the generated control instruction of “warn the male at the second spot”′ using the blockchain network BCN. At this time, the server 1 manages the encrypted control instruction using the blockchain network BCN.

In Step ST26, the BC ultra-light node in the autonomous-decentralized chip CP of the output cell 3-1 acquires the encrypted control instruction managed using the blockchain network BCN.

In Step ST27, the firmware in the autonomous-decentralized chip CP of the output cell 3-1 decrypts the encrypted control instruction. Then, the language conversion AI in the autonomous-decentralized chip CP of the output cell 3-1 converts the control instruction into a digital signal indicating specific contents of control of the control device. Specifically, for example, the language conversion AI in the autonomous-decentralized chip CP of the output cell 3-1 converts the control instruction of “warn the male at the second spot” into a digital signal causing the control device (e.g., actuator or control unit of a warning device) to “activate the warning device” around the second spot. That is, for example, the language conversion AI in the autonomous-decentralized chip CP of the output cell 3-1 outputs a control signal (digital signal) which is digital data for activating the warning device. Note that although not shown in the figure, the BC ultra-light node in the autonomous-decentralized chip CP of the output cell 3-1 can also cause the BC full node to manage the control device operation of “activating the warning device around the second spot” using the blockchain network BCN.

In Step ST28, the actuator (one example of the control device) is driven according to the control signal (digital signal) which is the digital data for “activating the warning device” around the second spot. As a result, the actuator (one example of the control device) is operated according to the control signal of “warning the male at the second spot” from the central AI 61. In this manner, based on the data on the images captured by the cameras, such as “the male who is not normally present at the first spot is present at the first time point” and “the male who is not normally present at the second spot is present at the second time point”, the not-shown warning device around the second spot is activated to warn the male.

In Step ST29, the checking terminal 4 provides a manager of the equipment (e.g., factory) with the information managed using the blockchain network BCN. That is, the manager of the equipment (e.g., factory) can check the information provided to the checking terminal 4, which includes the data on the images captured at the first and second time points at the first and second spots by the cameras, the input data (language data) such as “the male who is not normally present at the first spot is present at the first time point” and “the male who is not normally present at the second spot is present at the second time point”, the output data (language data) with the control instruction of “warn the male at the second spot”, and the control device operation of “activating the warning device” around the second spot. These types of information are managed using the blockchain network BCN, and therefore, are provided as, e.g., the non-manipulated history of input and output to the manager of the equipment (e.g., factory).

With the above-described configuration and operation, the present service has the following characteristics as described above with reference to FIG. 1. First, the existing AI educated with the language can be employed as the central AI 61. Thus, in the present service, the development cost and the operation cost can be reduced as a whole.

Second, the AI processing is performed on the edge side, and therefore, the burden of the processing using the central AI 61 is reduced. That is, the central AI 61 does not need to perform the perceptual expression processing (verbalization), and therefore, the burden is reduced. That is, it can be said that the decentralized AI processing is implemented. The effect of this decentralized processing becomes more prominent as the number of input cells and the number of output cells on the edge side increase.

Third, in the present service, the data is ensured using the blockchain network BCN, and therefore, the safe AI system is implemented. As a result, in the present service, the data is ensured using the blockchain network BCN, and therefore, it is impossible for a fake input cell 2-3 to operate and the safe AI system can be implemented.

Note that in the above-described example, the case where the language AI outputs the data indicating that the male who is not normally present at the certain spot is present at the certain time point has been described, but the language AI can make various types of output. Specifically, for example, perceptual expressions of “sparking (from a device installed) at the first spot”, “smoking at the first spot”, and “fire at the first spot” may be output.

The outline of the present service to which the “autonomous-decentralized AI blockchain cell” is applied has been described above with reference to FIG. 8. The configuration of the information processing system applied when the service shown in FIG. 8 to which the “autonomous-decentralized AI blockchain cell” is applied is provided as the present service is basically similar to that shown in FIGS. 2 and 3.

Note that as shown in FIG. 1, the input cell 2-r includes a camera CAM-p as an input unit. Moreover, the input cell 2-r has, as an autonomous-decentralized chip CP, part or the entirety of, e.g., a CPU, a ROM, and a RAM.

Various types of processing can be executed by cooperation of various types of hardware of the server 1 as described above and various types of software. As a result, the above-described present service can be provided. Hereinafter, a functional configuration of the information processing system for providing the present service of FIG. 8 will be described.

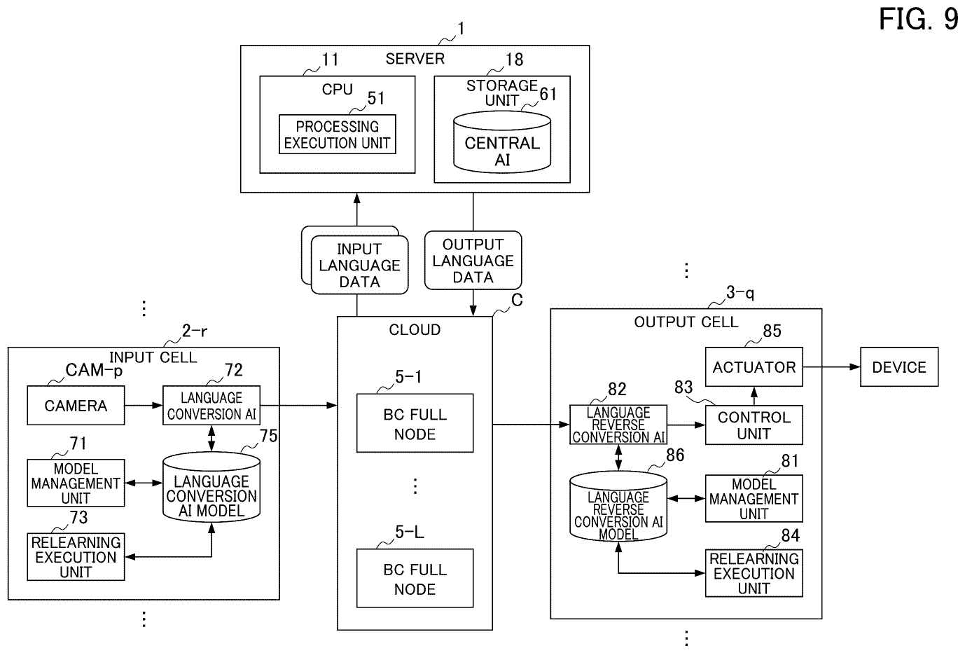

FIG. 9 is a functional block diagram showing one example of the functional configuration of the information processing system for providing the service of FIG. 8.

As shown in FIG. 9, in the CPU 11 of the server 1, a processing execution unit 51 functions. A storage unit 18 stores a model of the central AI 61.

In the input cell 2-r, a model management unit 71, a language conversion AI 72, and a relearning execution unit 73 function as the autonomous-decentralized chip CP. The input cell 2-r has the camera CMA-p as an input unit. Moreover, the storage unit of the input cell 2-r stores a language conversion AI model 75.

In the output cell 3-q, a model management unit 81, a language reverse conversion AI 82, a control unit 83, and a relearning execution unit 84 function as the autonomous-decentralized chip CP. The output cell 3-q has an actuator 85 as an output unit. Moreover, the storage unit of the output cell 3-q stores a language reverse conversion AI model 86.

The processing execution unit 51 acquires, as input data, input language data from one or more input cells 2-r, executes predetermined processing using the input data, and outputs, as output data, one or more pieces of output language data indicating a processing execution result. The processing execution unit 51 acquires the stored input data using the blockchain network BCN.

The model management unit 71 manages the language conversion AI model 75 for receiving data on an image captured by the camera CAM-p, converting the data into language data, and outputting the language data with the language conversion AI model 75 stored in the storage unit. Specifically, for example, in a case where the male image which has not been captured so far is shown, the model management unit 71 converts the image into, e.g., the language data with “the male who is not normally present at the first spot is present at the first time point”, and outputs such language data.

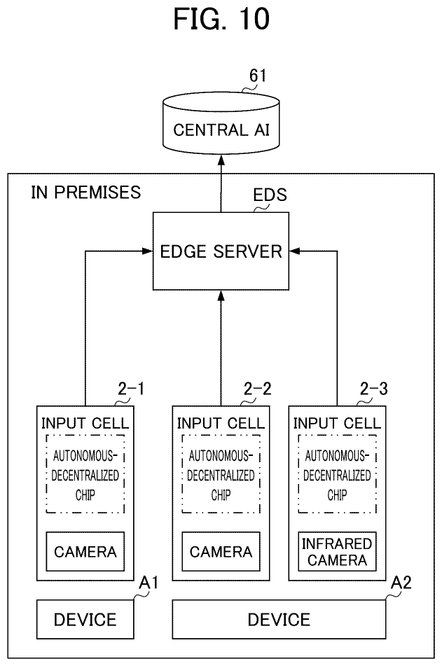

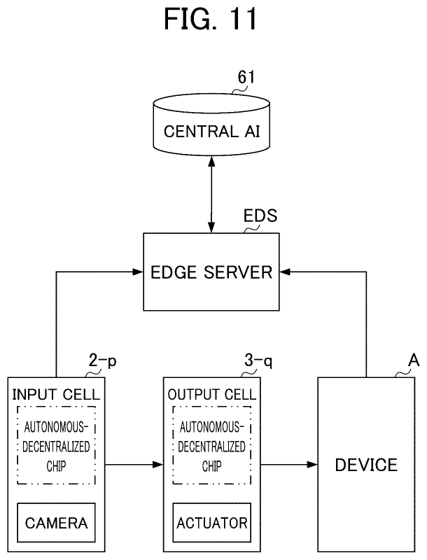

The language conversion AI 72 acquires, from the camera CAM-p that captures an image of a target region, data on the image of the target region, inputs the data to the language conversion AI model 75, and outputs language data output from such a model as at least part of input language data for the server 1. The processing after verbalization by the language conversion AI 72 is basically similar to that described above. Thus, description thereof will be omitted. Hereinafter, an example where the present information processing system is applied and used to monitor a plurality of devices arranged in the premises will be described with reference to FIGS. 10 and 11. FIG. 10 is a diagram showing an example where the service shown in FIG. 1 is used to manage devices arranged in the premises. In the example of FIG. 10, two devices A1, A2 are arranged in the premises. That is, for example, the devices A1, A2 are devices arranged on a manufacturing line in the premises such as a factory.

The input cell 2-1 is disposed for the device A1. This shows, for example, a state in which the camera CAM-1 of the input cell 2-1 captures the image of the target region which is, e.g., the device A1 on the manufacturing line or the periphery thereof. Specifically, for example, the sensor captures an image of the device Al as an image for grasping the appearance of the device A1 and the surrounding statuses of a predetermined meter and the device A1.

The input cells 2-2, 2-3 are arranged for the device A2. This shows a state in which two cameras, i.e., the camera CMA-2 and the infrared camera CAM-3, of the two input cells 2-2, 2-3 capture an image of one device A2. That is, although one input cell 2-1 is disposed for the device A1, the plurality of input cells is arranged for one device A2. Here, the input cell 2-5 captures the image of the target region by the infrared camera CAM-3. With this configuration, the input cell 2-5 can acquire, e.g., an image from which an event in which abnormal heat generation has occurred in the device A2 can be grasped.

Each of the input cells 2-1 to 2-3 converts the data measured by the sensor into language data, and transmits the language data to an edge server EDS. In this manner, the data on the plurality of devices A1, A2 in the premises is collected.

With this configuration, e.g., breakdown can be detected/predicated from the operation statuses of various devices (e.g., manufacturing robot (line), room temperature control, and lighting control) used in the premises. Further, unmanned monitoring in the premises (e.g., factory, hospital, or condominium) shown in FIG. 5 can be performed. As described above, in a conventional monitoring system, in a case where, e.g., an accident has occurred and data (abnormal values) is transmitted at once from many sensors, a central monitoring device sequentially performs the processing, and for this reason, it may take considerable time to undertake measures, such as outputting an alarm to a user (e.g., guard) or operating emergency equipment (e.g., fire extinguishing by a sprinkler).

On the other hand, in the present information processing system, each input cell performs the conversion into the language data, and therefore, the processing can be decentralized and measures can be taken at high speed as a whole.

Further, the processing is performed with no control instruction from the central AI 61, and therefore, measures can be taken at higher speed. FIG. 11 is a diagram showing an example of the flow of information processing when measures are taken at higher speed in the premises of FIG. 10. In the example of FIG. 11, language data is provided from the input cell 2-r to the output cell 3-q. That is, the language data from the input cell 2-r may be provided to the output cell 3-q without the central AI 61. The input cell 2-r, the output cell 3-q, etc. preferably have the following basic logics in the “autonomous-decentralized AI blockchain audiovisual cell”.

First, the input cell 2-r preferably has an “autonomous abnormality detection logic”. That is, the “autonomous abnormality detection logic” is a logic for performing, in each input cell 2-r, processing of autonomously analyzing a camera image and issuing an alarm. As described above, the input cell 2-r can detect, as an abnormal state (state which is not normal), the state in which the male image who is not normally present is shown in the image. For example, the input cell 2-r may detect, e.g., overheating of the device, fire, abnormal action (e.g., action of being violent, asking for help, or being chased), entrance into a banned area, and entrance of a dangerous animal. As described above with reference to FIG. 5, the infrared camera is used in addition to the normal camera capable of capturing a visible light as shown in FIG. 1, and therefore, a phenomenon which cannot be detected by the normal camera, such as abnormal overheating inside and outside the device or invisible high-temperature fire behind a wall, can be detected. Moreover, the input cell 2-r preferably further has a microphone as an input unit. With this configuration, for example, sound generated due to, e.g., human voice or an accident can be used in combination with an image, and detection accuracy can be improved.

Second, the input cell 2-r preferably has a “comparison-to-past (self-learning) logic”. That is, the “comparison-to-past (self-learning) logic” is a logic with which the relearning execution unit 73 of the input cell 2-r functions to learn such that detection is made based on information obtained by the input cell 2-r itself and other input cells in the past. Specifically, for example, the relearning execution unit 73 receives an image of a predetermined target person and information on the feature of the target person from the high-order server (e.g., edge server EDS in FIG. 5), and performs relearning (self-learning) to detect that the image of the target person is actually included in the image. Note that even in the case of the detection by the input cell 2-r during the relearning (self-learning), the output cell 3-q can be operated to sound an alarm as in FIG. 6.

Third, the present system preferably has an “automatic tracking logic”. The automatic tracking logic is a logic for automatically tracking, in each of the plurality of input cells 2-r, a predetermined target using information indicating that each input cell 2-r has detected the predetermined target. Specifically, for example, the high-order server (e.g., edge server EDS of FIG. 5) collects, e.g., the target person information detected by each of the plurality of input cells 2-r. Then, the high-order server estimates, at each location in the predetermined region imaged by each input cell 2-r, the route of movement of, e.g., the target person and the future location thereof based on the information indicating that the target person has been detected, thereby automatically tracking the target person.

Fourth, the present system preferably has a “consciousness communication logic”. The consciousness communication logic is a logic for outputting, from each of the plurality of input cells 2-r, a human language expressing human consciousness and intention at the same time as the output of the digital image data. That is, as shown in FIG. 1, the input cell 2-r manage the data on the captured image (including a still image and a moving image) using the blockchain network BCN, and at the same time, outputs the language expression corresponding to the human consciousness and intention. Specifically, for example, a language expression such as “an abnormal temperature has been detected” or “a vigorously-moving person has been detected” is output from the input cell 2-r. The language expression is output as described above, and therefore, the existing central AI capable of making language input can think and make a determination. Here, a difference between the edge server EDS in, e.g., FIGS. 5 and 6 and the central AI 61 will be described. That is, as described above, the central AI 61 normally basically makes a determination. However, e.g., in a case where it is not necessary to wait for a determination from the central AI 61, the output cell 3-q can be operated via the edge server EDS.

Fifthly, the present system preferably has a “self-measures logic”. The self-measures logic is a logic for executing operation in each of the plurality of input cells 3-q without the central AI 61 or the edge server EDS. Specifically, unlike, e.g., a simple monitoring camera, the output cell 3-q can output an alarm or locally extinguish fire by, e.g., a sprinkler in a case where it is not necessary to ask the central AI 61 for a determination and it is dangerous unless otherwise measures are taken immediately, as described with reference to FIG. 6. That is, the information processing is implemented to undertake measures at high speed.

As described above, the input cell 2-r and output cell 3-q of the present information processing system include audiovisual units such as a camera or a microphone, make, by IT, the concept of an identity a reality, and are configured as the so-called “autonomous-decentralized AI blockchain audiovisual cells”.

One embodiment of the present invention has been described above, but the present invention is not limited to the above-described embodiment and changes, modifications, etc. made within a scope in which the object of the present invention can be accomplished are included in the present invention.

In the above-described embodiment, the input cell 2-r generates the language data from the data on the image captured by the camera but is not particularly limited thereto. That is, for example, the input cell 2-r may have a function of converting a “language” for humans into a “language” for machines. Specifically, for example, the input cell 2-r may acquire, from a person, a human language of “there is a suspicious person”, and convert the human language into an identifier associated in advance with the human language in the information processing device and indicating that “there is a suspicious person”. With this configuration, a result of checking with, e.g., human eyes can also be employed as the input language data in the present information processing system.

As described above, the “autonomous-decentralized AI blockchain audiovisual cell” is the unit of the information processing device capable of executing the processing related to the blockchain. Note that the information processing device is not limited to the personal computer or the server device and can be implemented as a chip which is an electronic component. Thus, the information processing device can be easily incorporated into conventional various devices. That is, the autonomous-decentralized chip CP of FIG. 1 may be implemented as a chip and may be built in the camera and operate as an input cell.

The “autonomous-decentralized AI blockchain cell” and the autonomous-decentralized AI blockchain audiovisual cell“ as described above are connected to each other via a predetermined network, particularly a wireless network, in the premises, so that convenience can be significantly improved by the autonomous-decentralized processing.

Regardless of whether wired connection, wireless connection, or a combination thereof is employed as a network connection method, a function allowing cooperation of many input cells 2 (the “autonomous-decentralized AI blockchain cell” and the “autonomous-decentralized AI blockchain audiovisual cell”) needs to be fulfilled to integrally manage and effectively use these input cells 2.

That is, in a conventional system that causes a central management (centralized) server to manage many sensors, the load of the central management server increases as the number of sensors increases. Conversely, with the input cells of the present embodiment as described above, the benefit of the decentralized AI increases and the load of the central management server (central AI in the present embodiment) decreases as the number of sensors increases. This is the greatest advantage of the input cell 2 of the present embodiment. That is, the input cell 2 of the present embodiment is most effective in easily building not a conventional centralized system but a decentralized system. The above-described input cell 2 and output cell 3-q including the “autonomous-decentralized AI blockchain cell” and the “autonomous-decentralized AI blockchain audiovisual cell” preferably have the following basic logics.

First, the information processing system of the present embodiment preferably has a “self-position recognition logic”. That is, in order for the input cell 2 to autonomously determine a solution from abnormality detection and undertake measures, it is important for the input cell 2 to grasp the location where “the input cell 2 itself is present” by the input cell 2 itself. Specifically, for example, in a case where fire has occurred at the third floor, the input cell 2-1 at the third floor and the input cell 2-2 at the first floor are different from each other in processing to be performed preferentially. That is, the decentralized processing is necessary according to location and position.

Preferably, the input cell 2 can grasp the positional relationship of the input cell 2 itself, such as in which device and at which location the input cell 2 itself is installed and which one of other input cells 2 is located close to the input cell 2, through an entire map, i.e., an entire image. With this configuration, autonomous control (e.g., control processing from output cell 3) is allowed properly using the information from the plurality of input cells 2. Preferably for mapping for the entire map, each input cell 2 includes information acquirer that identifies a three-dimensional location, such as a GPS or an altitude sensor. With this configuration, in addition to notification from the high-order server (e.g., edge server EDS or server 1), the input cell 2 itself can identify and grasp the location (position) of the input cell 2 itself and the location and device from which an abnormality has been detected on the three-dimensional map. The map may be produced, updated, and managed by the high-order server. Notification to each “autonomous-decentralized AI blockchain cell” is made regularly, and therefore, the “autonomous-decentralized AI blockchain cells” can perform the decentralized processing using the uniform map. Note that by such 3D mapping, for example, the input cells 2 attached to moving objects such as flying drones can share location information. With this configuration, e.g., safe flight and substitute flight can be implemented using the input cells 2.

Second, the information processing system of the present embodiment preferably has an “input cell education logic”. That is, the high-order server (e.g., edge server EDS or server 1) inside or outside the premises, which manages the input cells 2, preferably integrally performs 3D mapping of the installation location of each input cell 2 based on the 3D map of the equipment or section (room and installation location in the case of a condominium) and three-dimensional coordinate information from each input cell 2, such as location and altitude information, and regularly notifies the latest map such that such a map is shared among all the input cells 2. In this case, to constantly notify the latest map, polling is regularly performed on each input cell 2 so that the 3D map can be updated based on information such as the availability of normal operation, a change in the location, and a status. With this configuration, for example, in a case where a broken-down input cell 2 is replaced or a case where an input cell 2 is newly added, the newly-installed input cell 2 itself can operate with autonomously understanding the position and role thereof without a person setting the position and the role.

Third, the information processing system of the present embodiment preferably has a “decentralized autonomous system”. Here, the decentralized autonomous system can be called a DAS, and specifically has the following configuration. That is, as described above, the input cell 2 has the logic allowing the autonomous (independent) determination and processing. Thus, for example, even in a case where the function of the server (e.g., edge server EDS) in the premises is temporarily stopped due to, e.g., breakdown or maintenance, the input cell 2 and the output cell 3 can monitor and undertake measures alone or in cooperation with each other. When the server (e.g., edge server EDS) in the premises is recovered (returned to a normal state), the input cell 2 and the output cell 3 can instantaneously recover the latest map and state from, e. g., the information distributed and held in the high-order server (e.g., edge server EDS) and return to normal operation. The input cell 2 and the output cell 3 are most effective in pursuing the task without causing a trouble even without the high-order server (e.g., edge server EDS), which is the greatest advantage of the decentralized autonomous system (DAS).

Fourthly, the information processing system of the present embodiment preferably has an “ethical logic”. That is, the high-order server (e.g., edge server EDS or server 1) inside or outside the premises performs the best education on each input cell 2 and the output cell 3 based on an analysis or prediction made by the server itself while making a prediction or determination as a whole. The education described here is performed because contents to be recognized vary according to device and environment in which each input cell 2 and the output cell are installed. Specifically, for example, even in the case of the same sensor information indicating 30 degrees, the meaning thereof varies according to device in which the input cell 2 is installed, such as whether the installation location of the input cell 2 is inside or outside a room. Moreover, for example, noise and vibration mean differently according to environment and machine. Thus, the perceptual expression output from the input cell 2 may be corrected such that language output close to a sense as if a person feels with one's skin is made as much as possible. Further, there are unique phrases according to business field and equipment, and for this reason, education with these unique phrases may be performed during the correction. Preferably, the input cell 2 and the output cell 3 can perform self-learning of an output language with conscious of the installation location, environment, and device of the cell itself while receiving correction information from the high-order server (e.g., edge server EDS or server 1).

For example, the system configuration shown in FIG. 2 and the hardware configuration of the server 1 shown in FIG. 3 are merely examples for accomplishing the object of the present invention, and the present invention is not limited thereto.

Moreover, the functional block diagrams shown in FIGS. 4 and 9 are merely examples, and the present invention is not limited thereto. That is, the information processing system of FIG. 2 is only required to have a function of executing the above-described series of processing as a whole, and the functional blocks and databases for implementing this function are not particularly limited to those of the examples of FIGS. 4 and 9.

The locations of the functional blocks are not limited to those of FIG. 5 and may be arbitrary. For example, at least part of the functional blocks on the server 1 side may be included in another information processing device.

The above-described series of processing may be executed by hardware or software. One functional block may be implemented by hardware alone, software alone, or a combination thereof.

In a case where the series of processing is executed by the software, programs forming the software are installed in, e.g., a computer from a network or a storage medium. The computer may be a computer incorporated into dedicated hardware. Alternatively, the computer may be a computer capable of executing various functions by installation of various programs, such as a general-purpose smartphone or personal computer other than a server.

The recording medium including these programs is not only a not-shown removable medium distributed separately from a device body to provide a user with the programs, but also a recording medium provided to a user with incorporated in advance into a device body, for example.

Note that in the present specification, the steps of describing the programs recorded in the recording medium include not only processing performed in chronological order, but also processing executed in parallel or individually.

As a summary of the description above, the information processing system to which the present invention is applied is only required to have the following configurations and may include various embodiments.

That is, the information processing system (e.g., information processing systems of FIGS. 4 and 9) to which the present invention is applied is an information processing system including a central device (e.g., servers 1 of FIGS. 4 and 9 or edge servers EDS of FIGS. 6 and 10) that executes predetermined processing using input data, and one or more first peripheral devices (e.g., input cells 2 of FIGS. 4 and 9) that provide the central device with at least part of the input data. The information processing system is only required to be configured such that the central device includes a processing executer (processing execution unit 51) that acquires, as input data, one or more pieces of perceptually-expressed data (input language data of FIGS. 4 and 9), executes predetermined processing using the input data, and outputs, as output data, one or more pieces of perceptually-expressed data indicating a processing execution result, and each of the one or more first peripheral devices includes a model manager (model management unit 71) that manages a model (e.g., language reverse conversion AI model 86) for receiving predetermined data (e.g., temperature data or image data), converting the predetermined data into the perceptually-expressed data (e.g., data corresponding to a “temperature increase” or data corresponding to “there is a suspicious person”), and outputting the perceptually-expressed data with the model stored in a predetermined storage medium, and a converter (language conversion AI 72) that acquires data (e.g., temperature data or image data) output from a sensor (e.g., sensor 74 of FIG. 4) that measures a physical quantity in a real world or a camera (e.g., camera of FIG. 9) that images a target region, inputs the data to the model, and outputs the perceptually-expressed data (e.g., data corresponding to a “temperature increase” or data corresponding to “there is a suspicious person”) from the model as at least part of the input data for the central device. With this configuration, convenience in management of equipment based on data from a plurality of sensors or cameras can be improved.

The information processing system further includes one or more second peripheral devices (output cell 3) that control a predetermined control target, and each of the one or more second peripheral devices includes a model manager (model management unit 81) that manages a model for receiving the perceptually-expressed data, converting the perceptually-expressed data into a predetermined physical quantity, and outputting the physical quantity with the model stored in a predetermined storage medium, and a controller (language reverse conversion AI 82 and control unit 83) that acquires at least part of the one or more pieces of perceptually-expressed data forming the output data from the central device, inputs the at least part of the one or more pieces of perceptually-expressed data to the model, inputs, as an instruction signal, a signal indicating the predetermined physical quantity from the model to the predetermined control target, thereby controlling the predetermined control target. With this configuration, the convenience in the management of the equipment based on the data from the plurality of sensors or cameras can be further improved.

The central device further includes a first peripheral device information acquirer (e.g., processing execution unit 51) that acquires, as first peripheral device information, location information (e.g., three-dimensional location information acquirable from a GPS or an altitude sensor) and information (e.g., data on the model itself, which influences a threshold for determining a temperature increase) on the model from the one or more first peripheral devices, and a map manager (e.g., processing execution unit 51) that generates or updates a three-dimensional map of equipment in which the one or more first peripheral devices are arranged based on the first peripheral device information and manages the three-dimensional map, and each of the one or more first peripheral devices further includes a location information acquirer (e.g., model management unit 71) that acquires the location information on the each of the one or more first peripheral devices, a first peripheral device information transmitter (e.g., model management unit 71) that provides the central device with the location information and the information on the model, and a first relearning executer (e.g., relearning execution unit 73 of FIG. 4) that executes relearning for updating the model based on the three-dimensional map managed by the central device and the location information. With this configuration, the convenience in the management of the equipment based on the data from the plurality of sensors or cameras can be further improved.

### COMPONENTS

1 Server
2 Input cell
3 Output cell
53
4 Checking terminal
5 Blockchain full node
11 CPU
20 Drive
31 Removable medium
51 Processing execution unit
61 Central AI
71 Model management unit
72 Language conversion AI
73 Relearning execution unit
74 Sensor
75 Language conversion AI model
CAM Camera
81 Model management unit
82 Language reverse conversion AI
83 Control unit
84 Relearning execution unit
85 Actuator
86 Language reverse conversion AI model

1. An information processing system comprising:
a central device that executes predetermined processing using input data; and
one or more first peripheral devices that provide the central device with at least part of the input data,
wherein the central device includes
a processing executer that acquires, as input data, one or more pieces of perceptually-expressed data, executes predetermined processing using the input data, and outputs, as output data, one or more pieces of perceptually-expressed data indicating a processing execution result, and
each of the one or more first peripheral devices includes
a model manager that manages a model for receiving predetermined data, converting the predetermined data into the perceptually-expressed data, and outputting the perceptually-expressed data with the model stored in a predetermined storage medium, and
a converter that acquires data output from a sensor that measures a physical quantity in a real world or a camera that images a target region, inputs the data to the model, and outputs the perceptually-expressed data from the model as at least part of the input data for the central device.

2. The information processing system according to claim 1, further comprising:
one or more second peripheral devices that control a predetermined control target,
wherein each of the one or more second peripheral devices includes
a model manager that manages a model for receiving the perceptually-expressed data, converting the perceptually-expressed data into a predetermined physical quantity, and outputting the physical quantity with the model stored in a predetermined storage medium, and
a controller that acquires at least part of the one or more pieces of perceptually-expressed data forming the output data output from the central device, inputs the at least part of the one or more pieces of perceptually-expressed data to the model, inputs, as an instruction signal, a signal indicating the predetermined physical quantity output from the model to the predetermined control target, thereby controlling the predetermined control target.

3. The information processing system according to claim 2, wherein
the central device further includes
a first peripheral device information acquirer that acquires, as first peripheral device information, location information and information on the model from the one or more first peripheral devices, and
a map manager that generates or updates a three-dimensional map of equipment in which the one or more first peripheral devices are arranged based on the first peripheral device information and manages the three-dimensional map, and
each of the one or more first peripheral devices further includes
a location information acquirer that acquires the location information on the each of the one or more first peripheral devices,
a first peripheral device information transmitter that provides the central device with the location information and the information on the model, and
a first relearning executer that executes relearning for updating the model based on the three-dimensional map managed by the central device and the location information.

4. An information processing method executed by an information processing system including a central device that executes predetermined processing using input data, and one or more first peripheral devices that provide the central device with at least part of the input data, comprising:
as a step executed by the central device,
a processing execution step of acquiring, as input data, one or more pieces of perceptually-expressed data, executing predetermined processing using the input data, and outputting, as output data, one or more pieces of perceptually-expressed data indicating a processing execution result; and
as a step executed by each of the one or more first peripheral devices,
a model management step of managing a model for receiving predetermined image data, converting the predetermined image data into the perceptually-expressed data, and outputting the perceptually-expressed data with the model stored in a predetermined storage medium, and
a conversion step of acquiring data output from a sensor that measures a physical quantity in a real world or a camera that images a target region, inputting the data to the model, and outputting the perceptually-expressed data from the model as at least part of the input data for the central device.

5. A non-transitory computer readable medium storing a program causing a computer that controls an information processing system including a central device that executes predetermined processing using input data, and one or more first peripheral devices that provide the central device with at least part of the input data, the program causing
part of the computer that controls the central device to execute control processing including
a processing execution step of acquiring, as input data, one or more pieces of perceptually-expressed data, executing predetermined processing using the input data, and outputting, as output data, one or more pieces of perceptually-expressed data indicating a processing execution result, and
part of the computer that controls each of the one or more first peripheral devices to execute control processing including
a model management step of managing a model for receiving predetermined image data, converting the predetermined image data into perceptually-expressed data, and outputting the perceptually-expressed data with the model stored in a predetermined storage medium, and a conversion step of acquiring data output from a sensor that measures a physical quantity in a real world or a camera that images a target region, inputting the data to the model, and outputting the perceptually-expressed data from the model as at least part of the input data for the central device.

6. An information processing system comprising:
a central device that executes predetermined processing using input data; and
one or more first peripheral devices that provide the central device with at least part of the input data,
wherein the central device includes
a processing executer that acquires, as input data, one or more pieces of perceptually-expressed data, executes predetermined processing using the input data, and outputs, as output data, one or more pieces of perceptually-expressed data indicating a processing execution result, and
each of the one or more first peripheral devices includes
a converter that inputs, to a model that when a signal indicating a predetermined physical quantity is inputted, converts the inputted signal into the perceptually-expressed data and outputs the converted data, a signal, outputted from a sensor that detects a predetermined physical quantity in a real world, indicating the predetermined physical quantity, and outputs the perceptually-expressed data outputted from the model as at least part of the input data of the central device.

7. The information processing system according to claim 6, further comprising:
one or more second peripheral devices that control a predetermined control target,
wherein each of the one or more second peripheral devices includes
a controller that inputs, to a to a model that when the perceptually-expressed data is inputted, converts the perceptually-expressed data into a predetermined physical quantity and outputs the physical quantity, at least part of the one or more pieces of perceptually-expressed data forming output data outputted from the central device, and inputs a signal indicating the predetermined physical quantity outputted from the model to the predetermined control target as an instruction signal, thereby controlling the predetermined control target.

8. The information processing system according to claim 7, wherein
each of the one or more first peripheral devices further includes a first relearning executer that executes relearning for updating the model, and
each of the one or more second peripheral devices further includes a second relearning executer that executes relearning for updating the model.

9. The information processing system according to claim 7, wherein
the first peripheral device further includes a first peripheral storage controller that stores at least part of the input data of the central device outputted from the converter using a technique of blockchain or distributed management ledger,
the central device further includes
an input data acquirer that acquires the input data stored using the technique of blockchain or distributed management ledger to provide the processing executer with the data, and
a central storage controller that stores the output data outputted from the processing executer using the technique of blockchain or distributed management ledger, and
the second peripheral device further includes an output data acquirer that acquires the output data stored using the technique of blockchain or distributed management ledger to provide the controller with the data.

10. The information processing system according to claim 9, wherein the first peripheral device acquires a signal indicating the predetermined physical quantity, and autonomously determines processing contents as to what kind of perceptually-expressed data is outputted using the model according to types of the signal and the predetermined physical quantity.

11. An information processing method executed by an information processing system including a central device that executes predetermined processing using input data, and one or more first peripheral devices that provide the central device with at least part of the input data, comprising:
as a step executed by the central device,
a processing execution step of acquiring, as input data, one or more pieces of perceptually-expressed data, executing predetermined processing using the input data, and outputting, as output data, one or more pieces of perceptually-expressed data indicating a processing execution result; and
as a step executed by each of the one or more first peripheral devices,
a converting step of inputting, to a model that when a signal indicating a predetermined physical quantity is inputted, converts the inputted signal into the perceptually-expressed data and outputs the converted data, a signal, outputted from a sensor that detects a predetermined physical quantity in a real world, indicating the predetermined physical quantity, and outputting the perceptually-expressed data outputted from the model as at least part of the input data of the central device.

12. A non-transitory computer readable medium storing a program causing computers that each controls an information processing system including a central device that executes predetermined processing using input data, and one or more first peripheral devices that provide the central device with at least part of the input data, the program causing
part of the computers that controls the central device to execute control processing including
a converting step of inputting, to a model that when a signal indicating a predetermined physical quantity is inputted, converts the inputted signal into the perceptually-expressed data and outputs the converted data, a signal, outputted from a sensor that detects a predetermined physical quantity in a real world, indicating the predetermined physical quantity, and outputting the perceptually-expressed data outputted from the model as at least part of the input data of the central device,
part of the computers that controls each of one or more first peripheral devices to execute control processing including
a converting step of inputting, to a model that when a signal indicating a predetermined physical quantity is inputted, converts the inputted signal into the perceptually-expressed data and outputs the converted data, a signal, outputted from a sensor that detects a predetermined physical quantity in a real world, indicating the predetermined physical quantity, and outputting the perceptually-expressed data outputted from the model as at least part of the input data of the central device.
